(19) United States
(12) Patent Application Publication
(10) Pub. No.: US 2019/0188719 A1
(43) Pub. Date: Jun. 20, 2019

(54) Computer-Implemented System, Method, and Computer Program Product for Automatically Generating an Account Profile for at Least One User Associated with a Plurality of Account Identifiers

(71) Applicant: Visa International Service Association, San Francisco, CA (US)

(72) Inventors: Rajat Das, Foster City, CA (US); Michael Kenji Mori, San Mateo, CA (US)

(21) Appl. No.: 15/841,787

(22) Filed: Dec. 14, 2017

(51) Int. Cl. G06Q 20/40; G06F 17/30; G06Q 20/10; G06Q 20/36; G06Q 30/06

(52) U.S. Cl. CPC G06Q 20/4016; G06F 17/30702; G06F 17/30345; G06Q 30/06; G06Q 20/10; G06Q 20/367; G06F 17/30522

(57) ABSTRACT

A method for automatically generating an account profile for a user or household, including: determining a first key identification data element type; determining a first key identification data element value; determining a linking identification data element type different than the first key identification data element type; determining at least one linking identification data element value; determining at least one second key identification data element value; and generating an account profile for the user or profile, the user account profile comprising a plurality of key identification data element values associated with the at least one user. A system and computer program product for automatically generating an account profile for a user or household are also disclosed.

### BACKGROUND OF THE INVENTION

### Field of the Invention

The present invention relates to payment and transactional systems, and in one non-limiting embodiment or aspect, a computer-implemented method, system, and computer program product for automatically generating an account profile for at least one user associated with a plurality of account identifiers.

### Description of Related Art

In today's economy, consumers commonly carry multiple portable financial devices (e.g., credit cards and/or debit cards) in order to initiate transactions with merchants accepting such forms of payment. Most users, e.g., cardholders, have multiple portable financial devices in their possession, whether stored in their wallets, provisioned into their devices, e.g., tokens and/or e-wallets, or lodged with payment providers. For example, on average in the United States, most users have more than three portable financial devices in their possession. The multitude of payment methods makes it difficult for any single entity in the value chain to gain a holistic view of a user's payment activity. Because most services performed during a payment transaction are based on an individual portable financial device number (or value), information from the user's other accounts cannot be easily incorporated or assessed.

With the expansion of e-commerce-based transactions, managing the payment credentials and details at numerous online merchants is often difficult for the typical user or cardholder. Updating an account number or card expiration date requires the user to review months of statements to identify all of the online merchants where a specific portable financial device was used. In some cases, consumers forget about online subscriptions, such that portable financial devices continue to be charged when the services are no longer required or desired.

The majority of transaction risk models are based upon a specific portable financial device number (or value). However, if the totality of the cardholder's accounts can be identified, the aggregate transaction data leads to a better picture of the user's habits and activities, which provides a better understanding of each individual user from a modeling perspective. In addition, in some instances, the issuer may not be available to authorize a particular transaction. In these cases, the transaction service provider may engage in Stand-in Processing (STIP), wherein “stand-in” transaction authorization occurs based normally on the Bank Identification Number (BIN) and, potentially, the cardholder account number.

A majority of cardholders follow a regular transaction pattern with respect to any particular portable financial device. Sudden deviations from this regular pattern may signify changing financial circumstances, potentially impacting the ability of the cardholder to meet debt repayment obligations. For example, a consumer entering bankruptcy proceedings may suddenly initiate multiple transactions across all of their accounts with the knowledge that the monthly repayment will not be made to the issuers. This behavior is difficult to detect for an individual issuer with visibility to only one of the consumer's portable financial devices.

Therefore, there is a need in the art for an improved way of automatically identifying and building a user account profile to improve the intelligence of the user's entire portfolio of portable financial devices and associated accounts.

### SUMMARY OF THE INVENTION

According to a non-limiting embodiment or aspect, provided is a computer-implemented method for automatically generating an account profile for at least one user associated with a plurality of account identifiers, comprising: determining, with at least one processor, a first key identification data element type comprising at least one of the following: an account identifier, a primary account number, a token, an electronic wallet, an electronic device, or any combination thereof; determining, with at least one processor, a first key identification data element value corresponding with the at least one user; determining, with at least one processor, a linking identification data element type different than the first key identification data element type; based at least partially on the key identification data element value, determining, with at least one processor, at least one linking identification data element value corresponding to the first key identification data element value; based at least partially on the at least one linking identification data element value, determining, with at least one processor, at least one second key identification data element value; and generating, with at least one processor, an account profile for the at least one user, the user account profile comprising a plurality of key identification data element values associated with the at least one user.

In a non-limiting embodiment or aspect, the method further comprises determining, with at least one processor, a second linking identification data element type different than the second key identification data element type; based at least partially on the at least one second key identification data element value, receiving or determining, with at least one processor, at least one second linking identification data element value corresponding to the at least one second key identification data element value; and based at least partially on the at least one second linking identification data element value, determining, with at least one processor, at least one third key identification data element value.

In a non-limiting embodiment or aspect, the method further comprises determining, with at least one processor, user data associated with the at least one user; based at least partially on the user data, querying, with at least one processor, a central user database comprising update data corresponding to each of the key identification data element values in the user account profile; and modifying at least one key identification data element value in the user account profile with an updated key identification data element value corresponding to at least one key identification data element type. In a non-limiting embodiment or aspect, the method further comprises determining, with at least one processor, a linking identification data element type different than the at least one key identification data element type; based at least partially on the updated key identification data element value, receiving or determining, with at least one processor, at least one linking identification data element value corresponding to the updated key identification data element value; based at least partially on the at least one linking identification data element value, determining, with at least one processor, at least one second key identification data element value; and updating, with at least one processor, the user account profile for the at least one user with the at least one second key identification data element value.

In a non-limiting embodiment or aspect, the at least one user comprises a plurality of users associated with each other.

In a non-limiting embodiment or aspect, the method further comprises identifying, with at least one processor, at least one transaction associated with at least one key identification data element value in the user account profile; determining, with at least one processor, a transaction timeframe corresponding to the at least one transaction; and based on the transaction timeframe, assigning, with at least one processor, an assessment value to the at least one key identification data element value.

In a non-limiting embodiment or aspect, the method further comprises identifying, with at least one processor, at least one charge-back transaction associated with at least one key identification data element value in the user account profile; and in response to determining that the at least one charge-back transaction is associated with a fraud category, flagging, with at least one processor, the at least one key identification data element value in the user account profile.

In a non-limiting embodiment or aspect, the key identification data element value comprises a primary account number of the at least one user, and the method further comprises: in response to failing to identify an expiration date of the primary account number, identifying, with at least one processor, at least one transaction associated with the primary account number; determining, with at least one processor, the expiration date of the primary account number from transaction data corresponding to the at least one transaction; and flagging, with at least one processor, the primary account number in the user account profile. In a non-limiting embodiment or aspect, the method further comprises updating, with at least one processor, the expiration date associated with the flagged primary account number in the user account profile. In a non-limiting embodiment or aspect, the method further comprises querying, with at least one processor, a central user database comprising account data corresponding to the at least one user; and in response to determining that the primary account number has changed, updating, with at least one processor, the primary account number in the user account profile.

In a non-limiting embodiment or aspect, the method further comprises transmitting, with at least one processor, specified data corresponding to at least one of the key identification data element values in the user account profile to at least one merchant system.

In a non-limiting embodiment or aspect, the method further comprises extracting, with at least one processor, a transaction value from transaction data of a current transaction corresponding to a first key identification data element value between the at least one user and a merchant, a transaction value; extracting, with at least one processor, a transaction value from transaction data of a previous transaction corresponding to the first key identification data element value between the at least one user and the merchant; comparing, with at least one processor, the transaction value of the current transaction and the transaction value of the previous transaction; and in response to determining that the transaction values are different, generating, with at least one processor, at least one alert message.

In a non-limiting embodiment or aspect, the method further comprises in response to determining that a transaction associated with a first key identification data element value has been declined by a merchant system, selecting, with at least one processor, an alternate first key identification data element value; and transmitting, with at least one processor, the alternate first key identification data element value to the merchant system.

In a non-limiting embodiment or aspect, the method further comprises in response to determining that a recurring payment using at least one first key identification data element value has not occurred within a specified time period, generating, with at least one processor, an alert message; and transmitting, with at least one processor, the alert message to the at least one user.

In a non-limiting embodiment or aspect, the method further comprises generating, with at least one processor, a risk/fraud score associated with a first specified first key identification data element value; verifying, with at least one processor, a parameter of a transaction associated with the second specified first key identification data element value; and in response to the verified parameter, adjusting, with at least one processor, the risk/fraud score associated with the first specified first key identification data element value.

In a non-limiting embodiment or aspect, the method further comprises generating, with at least one processor, a spending profile associated with the key identification data element values; and in response to receiving a transaction authorization request and based at least partially on the spending profile, transmitting, with at least one processor, an authorization response message. In a non-limiting embodiment or aspect, the authorization response message is transmitted to at least one merchant. In a non-limiting embodiment or aspect, the method further comprises based at least partially on the spending profile, determining, with at least one processor, a spend limit value; and based at least partially on the spending limit value and a transaction value in the transaction authorization request, transmitting, with at least one processor, an authorization response message. In a non-limiting embodiment or aspect, the method further comprises modifying, with at least one processor, the spend limit value based at least partially on an updated spending profile. In a non-limiting embodiment or aspect, the spending profile comprises at least one of the following: transaction value, transaction timeframe, transaction pattern, user behavior data, merchant data, or any combination thereof.

According to a non-limiting embodiment or aspect, provided is a system for automatically generating an account profile for at least one user associated with a plurality of account identifiers, comprising at least one server computer including at least one processor, the at least one server computer programmed and/or configured to: determine, with at least one processor, a first key identification data element type comprising at least one of the following: an account identifier, a primary account number, a token, an electronic wallet, an electronic device, or any combination thereof; determine, with at least one processor, a first key identification data element value corresponding with the at least one user; determine, with at least one processor, a linking identification data element type different than the first key identification data element type; based at least partially on the key identification data element value, determine, with at least one processor, at least one linking identification data element value corresponding to the first key identification data element value; based at least partially on the at least one linking identification data element value, determine, with at least one processor, at least one second key identification data element value; and generate, with at least one processor, an account profile for the at least one user, the user account profile comprising a plurality of key identification data element values associated with the at least one user.

According to a non-limiting embodiment or aspect, provided is a computer program product automatically generating an account profile for at least one user associated with a plurality of account identifiers, comprising at least one non-transitory computer-readable medium including program instructions that, when executed by at least one processor, cause the at least one processor to: determine, with at least one processor, a first key identification data element type comprising at least one of the following: an account identifier, a primary account number, a token, an electronic wallet, an electronic device, or any combination thereof; determine, with at least one processor, a first key identification data element value corresponding with the at least one user; determine, with at least one processor, a linking identification data element type different than the first key identification data element type; based at least partially on the key identification data element value, determine, with at least one processor, at least one linking identification data element value corresponding to the first key identification data element value; based at least partially on the at least one linking identification data element value, determine, with at least one processor, at least one second key identification data element value; and generate, with at least one processor, an account profile for the at least one user, the user account profile comprising a plurality of key identification data element values associated with the at least one user.

Further non-limiting embodiments or aspects are set forth in the following numbered clauses:

Clause 1: A computer-implemented method for automatically generating an account profile for at least one user associated with a plurality of account identifiers, comprising: determining, with at least one processor, a first key identification data element type comprising at least one of the following: an account identifier, a primary account number, a token, an electronic wallet, an electronic device, or any combination thereof; determining, with at least one processor, a first key identification data element value corresponding with the at least one user; determining, with at least one processor, a linking identification data element type different than the first key identification data element type; based at least partially on the key identification data element value, determining, with at least one processor, at least one linking identification data element value corresponding to the first key identification data element value; based at least partially on the at least one linking identification data element value, determining, with at least one processor, at least one second key identification data element value; and generating, with at least one processor, an account profile for the at least one user, the user account profile comprising a plurality of key identification data element values associated with the at least one user.

Clause 2: The method of clause 1, further comprising: determining, with at least one processor, a second linking identification data element type different than the second key identification data element type; based at least partially on the at least one second key identification data element value, receiving or determining, with at least one processor, at least one second linking identification data element value corresponding to the at least one second key identification data element value; and based at least partially on the at least one second linking identification data element value, determining, with at least one processor, at least one third key identification data element value.

Clause 3: The method of clause 1 or 2, further comprising: determining, with at least one processor, user data associated with the at least one user; based at least partially on the user data, querying, with at least one processor, a central user database comprising update data corresponding to each of the key identification data element values in the user account profile; and modifying at least one key identification data element value in the user account profile with an updated key identification data element value corresponding to at least one key identification data element type.

Clause 4: The method of any of clauses 1-3, further comprising: determining, with at least one processor, a linking identification data element type different than the at least one key identification data element type; based at least partially on the updated key identification data element value, receiving or determining, with at least one processor, at least one linking identification data element value corresponding to the updated key identification data element value; based at least partially on the at least one linking identification data element value, determining, with at least one processor, at least one second key identification data element value; and updating, with at least one processor, the user account profile for the at least one user with the at least one second key identification data element value.

Clause 5: The method of any of clauses 1-4, wherein the at least one user comprises a plurality of users associated with each other.

Clause 6: The method of any of clauses 1-5, further comprising: identifying, with at least one processor, at least one transaction associated with at least one key identification data element value in the user account profile; determining, with at least one processor, a transaction timeframe corresponding to the at least one transaction; and based on the transaction timeframe, assigning, with at least one processor, an assessment value to the at least one key identification data element value.

Clause 7: The method of any of clauses 1-6, further comprising: identifying, with at least one processor, at least one charge-back transaction associated with at least one key identification data element value in the user account profile; and in response to determining that the at least one charge-back transaction is associated with a fraud category, flagging, with at least one processor, the at least one key identification data element value in the user account profile.

Clause 8: The method of any of clauses 1-7, wherein the key identification data element value comprises a primary account number of the at least one user, the method further comprises: in response to failing to identify an expiration date of the primary account number, identifying, with at least one processor, at least one transaction associated with the primary account number; determining, with at least one processor, the expiration date of the primary account number from transaction data corresponding to the at least one transaction; and flagging, with at least one processor, the primary account number in the user account profile.

Clause 9: The method of any of clauses 1-8, further comprising updating, with at least one processor, the expiration date associated with the flagged primary account number in the user account profile.

Clause 10: The method of any of clauses 1-9, further comprising: querying, with at least one processor, a central user database comprising account data corresponding to the at least one user; and in response to determining that the primary account number has changed, updating, with at least one processor, the primary account number in the user account profile.

Clause 11: The method of any of clauses 1-10, further comprising transmitting, with at least one processor, specified data corresponding to at least one of the key identification data element values in the user account profile to at least one merchant system.

Clause 12: The method of any of clauses 1-11, further comprising: extracting, with at least one processor, a transaction value from transaction data of a current transaction corresponding to a first key identification data element value between the at least one user and a merchant, a transaction value; extracting, with at least one processor, a transaction value from transaction data of a previous transaction corresponding to the first key identification data element value between the at least one user and the merchant; comparing, with at least one processor, the transaction value of the current transaction and the transaction value of the previous transaction; and in response to determining that the transaction values are different or a difference between the transaction values exceeds a predetermined tolerance level, generating, with at least one processor, at least one alert message.

Clause 13: The method of any of clauses 1-12, further comprising: in response to determining that a transaction associated with a first key identification data element value has been declined by a merchant system, selecting, with at least one processor, an alternate first key identification data element value; and transmitting, with at least one processor, the alternate first key identification data element value to the merchant system.

Clause 14: The method of any of clauses 1-13, further comprising: in response to determining that a recurring payment using at least one first key identification data element value has not occurred within a specified time period, generating, with at least one processor, an alert message; and transmitting, with at least one processor, the alert message to the at least one user.

Clause 15: The method of any of clauses 1-14, further comprising: generating, with at least one processor, a risk/fraud score associated with a first specified first key identification data element value; verifying, with at least one processor, a parameter of a transaction associated with the second specified first key identification data element value; and in response to the verified parameter, adjusting, with at least one processor, the risk/fraud score associated with the first specified first key identification data element value.

Clause 16: The method of any of clauses 1-15, further comprising: generating, with at least one processor, a spending profile associated with the key identification data element values; and in response to receiving a transaction authorization request and based at least partially on the spending profile, transmitting, with at least one processor, an authorization response message.

Clause 17: The method of any of clauses 1-16, wherein the authorization response message is transmitted to at least one merchant.

Clause 18: The method of any of clauses 1-17, further comprising: based at least partially on the spending profile, determining, with at least one processor, a spend limit value; and based at least partially on the spending limit value and a transaction value in the transaction authorization request, transmitting, with at least one processor, an authorization response message.

Clause 19: The method of any of clauses 1-18, further comprising modifying, with at least one processor, the spend limit value based at least partially on an updated spending profile.

Clause 20: The method of any of clauses 1-19, wherein the spending profile comprises at least one of the following: transaction value, transaction timeframe, transaction pattern, user behavior data, merchant data, or any combination thereof.

Clause 21: A system for automatically generating an account profile for at least one user associated with a plurality of account identifiers, comprising at least one server computer including at least one processor, the at least one server computer programmed and/or configured to: determine, with at least one processor, a first key identification data element type comprising at least one of the following: an account identifier, a primary account number, a token, an electronic wallet, an electronic device, or any combination thereof; determine, with at least one processor, a first key identification data element value corresponding with the at least one user; determine, with at least one processor, a linking identification data element type different than the first key identification data element type; based at least partially on the key identification data element value, determine, with at least one processor, at least one linking identification data element value corresponding to the first key identification data element value; based at least partially on the at least one linking identification data element value, determine, with at least one processor, at least one second key identification data element value; and generate, with at least one processor, an account profile for the at least one user, the user account profile comprising a plurality of key identification data element values associated with the at least one user.

Clause 22: A computer program product automatically generating an account profile for at least one user associated with a plurality of account identifiers, comprising at least one non-transitory computer-readable medium including program instructions that, when executed by at least one processor, cause the at least one processor to: determine, with at least one processor, a first key identification data element type comprising at least one of the following: an account identifier, a primary account number, a token, an electronic wallet, an electronic device, or any combination thereof; determine, with at least one processor, a first key identification data element value corresponding with the at least one user; determine, with at least one processor, a linking identification data element type different than the first key identification data element type; based at least partially on the key identification data element value, determine, with at least one processor, at least one linking identification data element value corresponding to the first key identification data element value; based at least partially on the at least one linking identification data element value, determine, with at least one processor, at least one second key identification data element value; and generate, with at least one processor, an account profile for the at least one user, the user account profile comprising a plurality of key identification data element values associated with the at least one user.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a,” “an,” and “the” include plural referents unless the context clearly dictates otherwise.

### BRIEF DESCRIPTION OF THE DRAWINGS

Additional advantages and details of the invention are explained in greater detail below with reference to the exemplary embodiments that are illustrated in the accompanying schematic figures, in which:

FIG. 1 is a diagram of a non-limiting embodiment of an environment in which systems, devices, products, apparatus, and/or methods, described herein, may be implemented according to the principles of the present invention;

FIG. 2 is a diagram of a non-limiting embodiment of components of one or more devices of FIG. 1;

FIG. 3 is a flowchart of a non-limiting embodiment of a process for determining and generating a user account profile; and

FIGS. 4-15 are diagrams of an implementation of a non-limiting embodiment of the process shown in FIG. 3.

### DESCRIPTION OF THE INVENTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments or aspects of the invention. Hence, specific dimensions and other physical characteristics related to the embodiments or aspects disclosed herein are not to be considered as limiting.

As used herein, the terms “communication” and “communicate” refer to the receipt or transfer of one or more signals, messages, commands, or other type of data. For one unit (e.g., any device, system, or component thereof) to be in communication with another unit means that the one unit is able to directly or indirectly receive data from and/or transmit data to the other unit. This may refer to a direct or indirect connection that is wired and/or wireless in nature. Additionally, two units may be in communication with each other even though the data transmitted may be modified, processed, relayed, and/or routed between the first and second unit. For example, a first unit may be in communication with a second unit even though the first unit passively receives data and does not actively transmit data to the second unit. As another example, a first unit may be in communication with a second unit if an intermediary unit processes data from one unit and transmits processed data to the second unit. It will be appreciated that numerous other arrangements are possible.

As used herein, the term “transaction service provider” may refer to an entity that receives transaction authorization requests from merchants or other entities and provides guarantees of payment, in some cases through an agreement between the transaction service provider and an issuer institution. The terms “transaction service provider” and “transaction service provider system” may also refer to one or more computer systems operated by or on behalf of a transaction service provider, such as a transaction processing server executing one or more software applications. A transaction processing server may include one or more processors and, in some non-limiting embodiments, may be operated by or on behalf of a transaction service provider.

As used herein, the term “issuer institution” or “issuer” may refer to one or more entities, such as a bank, that provide accounts to customers for conducting payment transactions, such as initiating credit and/or debit payments. For example, an issuer institution may provide an account identifier, such as a personal account number (PAN), to a customer that uniquely identifies one or more accounts associated with that customer. The account identifier may be embodied on a physical financial instrument, such as a payment card, and/or may be electronic and used for electronic payments. The terms “issuer institution,” “issuer,” “issuer bank,” and “issuer system” may also refer to one or more computer systems operated by or on behalf of an issuer institution, such as a server computer executing one or more software applications. For example, an issuer system may include one or more authorization servers for authorizing a payment transaction.

As used herein, the term “account identifier” may include one or more PANs, tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more databases such that they can be used to conduct a transaction without directly using the original account identifier. In some examples, an original account identifier, such as a PAN, may be associated with a plurality of tokens for different individuals or purposes. An issuer institution may be associated with a bank identification number (BIN) or other unique identifier that uniquely identifies it among other issuer institutions. Further, any type of account identifier may be referred to as an “identification data element type” or “key identification data element type,” while the content of the identifier may be referred to as an “identification data element value” or “key identification data element value.”

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant, such as a server computer executing one or more software applications. A “point-of-sale (POS) system,” as used herein, may refer to one or more computers and/or peripheral devices used by a merchant to engage in payment transactions with customers, including one or more card readers, near-field communication (NFC) receivers, RFID receivers, and/or other contactless transceivers or receivers, contact-based receivers, payment terminals, computers, servers, input devices, and/or other like devices that can be used to initiate a payment transaction.

As used herein, the term “mobile device” or “electronic device” may refer to one or more portable electronic devices configured to communicate with one or more networks. As an example, a mobile device may include a cellular phone (e.g., a smartphone or standard cellular phone), a portable computer (e.g., a tablet computer, a laptop computer, and the like), a wearable device (e.g., a watch, pair of glasses, lens, clothing, and/or the like), a personal digital assistant (PDA), and/or other like devices. The term “client device,” as used herein, refers to any electronic device that is configured to communicate with one or more servers or remote devices and/or systems. A client device may include a mobile device, a network-enabled appliance (e.g., a network-enabled television, refrigerator, thermostat, and/or the like), a computer, a POS system, and/or any other device or system capable of communicating with a network.

As used herein, the term “computing device” may refer to one or more electronic devices that are configured to directly or indirectly communicate with or over one or more networks. The computing device may be a mobile device. The computing device may not be a mobile device, such as a desktop computer. Furthermore, the term “computer” may refer to any computing device that includes the necessary components to receive, process, and output data, and normally includes a display, a processor, a memory, an input device, and a network interface. An “application” or “application program interface” (API) refers to computer code or other data sorted on a computer-readable medium that may be executed by a processor to facilitate the interaction between software components, such as a client-side front-end and/or server-side back-end for receiving data from the client. An “interface” refers to a generated display, such as one or more graphical user interfaces (GUIs) with which a user may interact, either directly or indirectly (e.g., through a keyboard, mouse, touchscreen, etc.).

As used herein, the terms “electronic wallet” and “electronic wallet application” refer to one or more electronic devices and/or software applications configured to initiate and/or conduct payment transactions. For example, an electronic wallet may include a mobile device executing an electronic wallet application and may further include server-side software and/or databases for maintaining and providing transaction data to the mobile device. An “electronic wallet provider” may include an entity that provides and/or maintains an electronic wallet for a customer, such as Google Wallet™, Android Pay®, Apple Pay®, Samsung Pay®, and/or other like electronic payment systems. In some non-limiting examples, an issuer bank may be an electronic wallet provider. Further, any type of electronic wallet may be referred to as an “identification data element type” or “key identification data element type,” while the content of the identifier may be referred to as an “identification data element value” or “key identification data element value.”

As used herein, the term “portable financial device” may refer to a payment card (e.g., a credit or debit card), a gift card, a smartcard, smart media, a payroll card, a healthcare card, a wrist band, a machine-readable medium containing account data, a keychain device or fob, an RFID transponder, a retailer discount or loyalty card, a mobile device executing an electronic wallet application, a personal digital assistant, a security card, an access card, a wireless terminal, and/or a transponder, as examples. The portable financial device may include a volatile or a non-volatile memory to store information, such as an account identifier or a name of the account holder. Further, the primary account number (or “PAN”) may be referred to as an “identification data element value” or “key identification data element value.”

The term “account data,” as used herein, refers to any data concerning one or more accounts for one or more users. Account data may include, for example, one or more account identifiers, user identifiers, transaction histories, balances, credit limits, issuer institution identifiers, and/or the like.

A transaction message may be generated based on one or more transaction parameters from the transaction data, such as the transaction value, a transaction code, a merchant identifier (e.g., a unique merchant identifier, a merchant name, a merchant location, and/or the like), and/or other information concerning the transaction.

As used herein, the term “server” may refer to or include one or more processors or computers, storage devices, or similar computer arrangements that are operated by or facilitate communication and processing for multiple parties in a network environment, such as the Internet, although it will be appreciated that communication may be facilitated over one or more public or private network environments and that various other arrangements are possible. Further, multiple computers, e.g., servers, or other computerized devices, such as POS devices, directly or indirectly communicating in the network environment may constitute a “system,” such as a merchant's POS system.

Non-limiting embodiments or aspects of the present invention are directed to a computer-implemented method, system, and computer program product for automatically generating an account profile for at least one user associated with a plurality of account identifiers. Non-limiting embodiment or aspects of the present invention provide an intelligent method and system to identify multiple directly or indirectly related accounts that are associated with a single user or a plurality of users, e.g., a household. Using only a single data point, i.e., a key identification data element value (e.g., a portable financial device number (or PAN), an identifier associated with a specific electronic device, an identifier associated with an electronic wallet, an identifier associate with a token, and the like), non-limiting embodiment or aspects of the present invention determine all potential accounts corresponding to or associated with the user or the household. By generating and managing the user's complete account portfolio, both the user and third parties, e.g., issuers, transaction service providers, merchants, and the like, have access to important information for engaging in technical and business decisions. Non-limiting embodiments or aspects of the present invention leverage the portfolio information in the user account profile for cardholder recurring billing management, transaction risk scoring, stand-in transaction processing, and consumer abnormal spending detection and analysis. In this way, the present invention allows users and households to more effectively manage their multiple accounts across multiple devices, and allows third parties to better serve the cardholder and protect against liability associated with fraud.

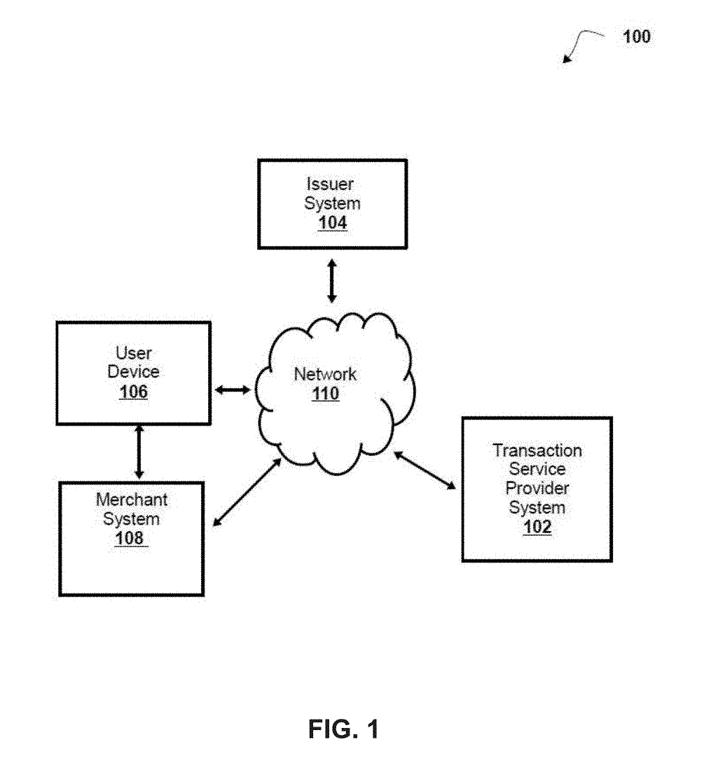

Referring now to FIG. 1, FIG. 1 is a diagram of an example environment 100 in which devices, systems, and/or methods, described herein, may be implemented. As shown in FIG. 1, environment 100 includes a transaction service provider system 102, an issuer system 104, a user device 106, a merchant system 108, and a network 110. Transaction service provider system 102, issuer system 104, user device 106, and/or merchant system 108 may interconnect (e.g., establish a connection to communicate) via wired connections, wireless connections, or a combination of wired and wireless connections.

Transaction service provider system 102 may include one or more devices capable of receiving information from issuer system 104, user device 106, and/or merchant system 108 via network 110 and/or communicating information to issuer system 104, user device 106, and/or merchant system 108 via network 110. For example, transaction service provider system 102 may include a computing device, such as a server (e.g., a transaction processing server), a group of servers, and/or other like devices. In some non-limiting embodiments, transaction service provider system 102 may be associated with a transaction service provider as described herein. In some non-limiting embodiments, transaction service provider system 102 may be in communication with a data storage device, which may be local or remote to the transaction service provider system 102. In some non-limiting embodiments, transaction service provider system 102 may be capable of receiving information from, storing information in, communicating information to, or searching information stored in data storage device.

Issuer system 104 may include one or more devices capable of receiving information from transaction service provider system 102 and/or user device 106 via a network (e.g., network 110) and/or communicating information to transaction service provider system 102, user device 106, and/or merchant system 108 via the network. For example, issuer system 104 may include a computing device, such as a server, a group of servers, and/or other like devices. In some non-limiting embodiments, issuer system 104 may be associated with an issuer institution as described herein. For example, issuer system 104 may be associated with an issuer institution that issued a credit account, debit account, credit card, debit card, and/or the like to a user associated with user device 106.

User device 106 may include one or more devices capable of receiving information from and/or communicating information to transaction service provider system 102, issuer system 104, and/or merchant system 108, via network 110. For example, user device 106 may include a client device and/or the like. In some non-limiting embodiments, user device 106 may or may not be capable of receiving information (e.g., from merchant system 108) via a short range wireless communication connection (e.g., an NFC communication connection, an RFID communication connection, a Bluetooth® communication connection, and/or the like), and/or communicating information (e.g., to merchant system 108) via a short range wireless communication connection.

Merchant system 108 may include one or more devices capable of receiving information from transaction service provider system 102, issuer system 104, and/or user device 106 via network 110 and/or communicating information to transaction service provider system 102, issuer system 104, and/or user device 106 via network 110. Merchant system 108 may also include a device capable of receiving information from user device 106 via network 110, a communication connection (e.g., an NFC communication connection, an RFID communication connection, a Bluetooth® communication connection, and/or the like) with user device 106, and/or the like, and/or communicating information to user device 106 via the network, the communication connection, and/or the like. For example, merchant system 108 may include a computing device, such as a server, a group of servers, a client device, a group of client devices, and/or other like devices. In some non-limiting embodiments, merchant system 108 may be associated with a merchant as described herein. In some non-limiting embodiments, merchant system 108 may include one or more user devices 106. For example, merchant system 108 may include user device 106 that allows a merchant to communicate information to transaction service provider system 102. In some non-limiting embodiments, merchant system 108 may include one or more devices, such as computers, computer systems, and/or peripheral devices capable of being used by a merchant to conduct a payment transaction with a user. For example, merchant system 108 may include a POS device and/or a POS system.

Network 110 may include one or more wired and/or wireless networks. For example, network 110 may include a cellular network (e.g., a long-term evolution (LTE) network, a third generation (3G) network, a fourth generation (4G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, and/or the like, and/or a combination of these or other types of networks.

The number and arrangement of devices and networks shown in FIG. 1 are provided as an example. There may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of environment 100 may perform one or more functions described as being performed by another set of devices of environment 100.

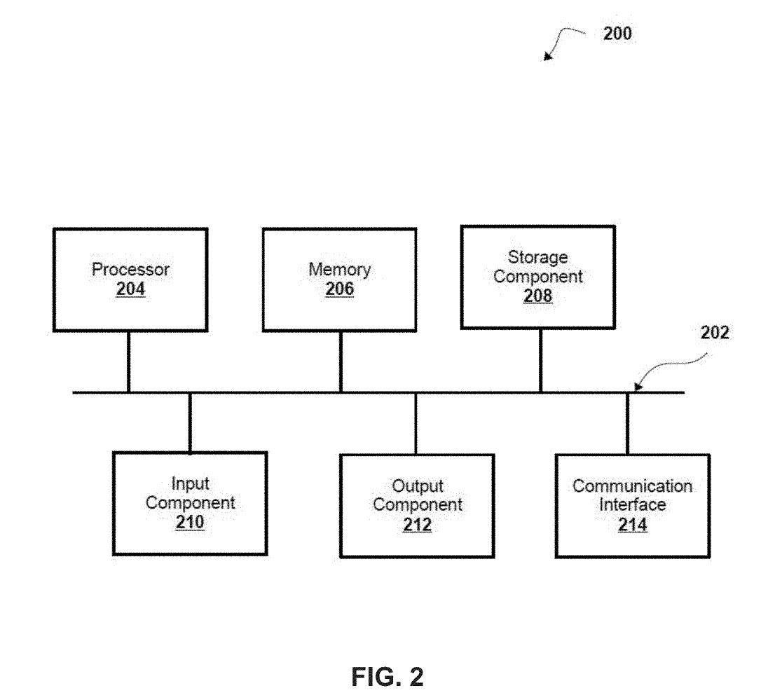

Referring now to FIG. 2, FIG. 2 is a diagram of example components of a device 200. Device 200 may correspond to one or more devices of transaction service provider system 102, and/or one or more devices of issuer system 104, user device 106, and/or merchant system 108. In some non-limiting embodiments, transaction service provider system 102, issuer system 104, user device 106, and/or merchant system 108 may include at least one device 200 and/or at least one component of device 200. As shown in FIG. 2, device 200 may include a bus 202, a processor 204, memory 206, a storage component 208, an input component 210, an output component 212, and a communication interface 214.

Bus 202 may include a component that permits communication among the components of device 200. In some non-limiting embodiments, processor 204 may be implemented in hardware, firmware, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read only memory (ROM), and/or another type of dynamic or static storage device (e.g., flash memory, magnetic memory, optical memory, etc.) that stores information and/or instructions for use by processor 204.

Storage component 208 may store information and/or software related to the operation and use of device 200. For example, storage component 208 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 210 may include a component that permits device 200 to receive information, such as via user input (e.g., a touch screen display, a keyboard, a keypad, a mouse, a button, a switch, a microphone, etc.). Additionally, or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.).

Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium (e.g., a non-transitory computer-readable medium) is defined herein as a non-transitory memory device. A memory device includes memory space located inside of a single physical storage device or memory space spread across multiple physical storage devices.

Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software.

The number and arrangement of components shown in FIG. 2 are provided as an example. In some non-limiting embodiments, device 200 may include additional components, fewer components, different components, or differently arranged components than those shown in FIG. 2. Additionally, or alternatively, a set of components (e.g., one or more components) of device 200 may perform one or more functions described as being performed by another set of components of device 200.

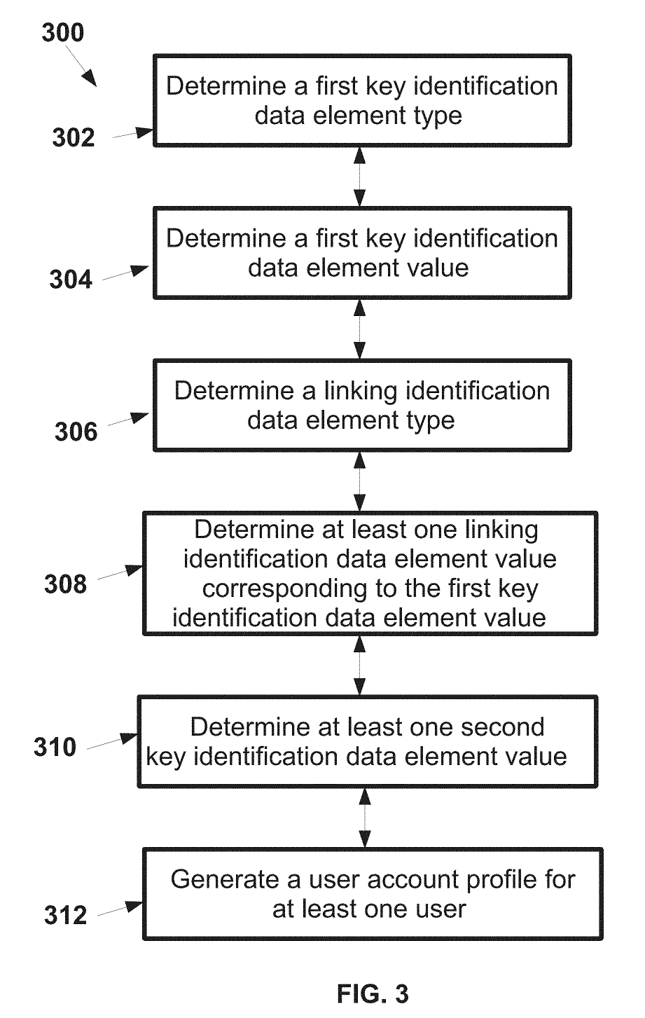

With reference to FIG. 3, FIG. 3 is a flowchart of a non-limiting embodiment or aspect of a process 300 for determining and generating a user account profile including account data regarding each of a user's accounts. The process 300 enables a transaction service provider, a issuer, a merchant, and/or a user to determine and automatically generate a user's account profile. In some non-limiting embodiments or aspects, the process 300 is used to generate a user account profile including all PANs that a user has access to for making payments in face-to-face or e-commerce environments. In some non-limiting embodiments or aspects, one or more of the steps of process 300 may be performed (e.g., completely, partially, etc.) by a consumer PAN householding system (hereinafter “CPH system”). In some non-limiting embodiments or aspects, the CPH system may be included in the transaction service provider system 102 (e.g., one or more devices of transaction service provider system 102). In some non-limiting embodiments, the CPH system may be included in another device or a group of devices separate from or including transaction service provider system 102, such as issuer system 104 (e.g., one or more devices of issuer system 104), user device 106, or merchant system 108 (e.g., one or more devices of merchant system 108).

As shown in FIG. 3, at step 302, process 300 includes determining a first key identification data element type. For example, the CPH system may receive data containing a key identification data element type and value. For example, a user may input the key identification element data into a software application on a user device, a computing device, or a POS device to be communicated to the CPH system. In some non-limiting embodiments or aspects, the key identification data element type may be a PAN, an account identifier, a device identification number (e.g., an iPhone device ID), a checkout username for a portable financial device account, a token number assigned to a PAN, an electronic wallet, an electronic device, and any combination thereof.

In some non-limiting embodiments or aspects, the user must establish the authority to use this key identification data element before the key identification data element data is sent to the CPH system. To verify that the user is authorized to use the key identification data element, the user will be required to enter additional information corresponding to the key identification data element to confirm the user's authorization to access the key identification data element. In some non-limiting embodiments or aspects, in the event the user inputs a PAN as the key identification data element type, the user may be required to input an expiration date, cvv2 verification number, or an address verification to confirm authorization for the user. In some non-limiting embodiments or aspects, in the event the user inputs a device identification number as the key identification data element type, a one-time password (OTP) may be sent to the user's device 106 for verification. The OTP may be sent in an email, text message, or similar communication to allow the user to access the OTP, which must be input into the user device 106 to confirm authorization for the user. In some non-limiting embodiments or aspects, in the event the user inputs a checkout username as the key identification data element type, the user may be required to input a checkout password to confirm authorization for the user. In some non-limiting embodiments or aspects, in the event the user inputs a token number assigned to a PAN as the key identification data element type, the user may be required to perform a consumer device cardholder verification method (CDCVM) to confirm authorization for the user.

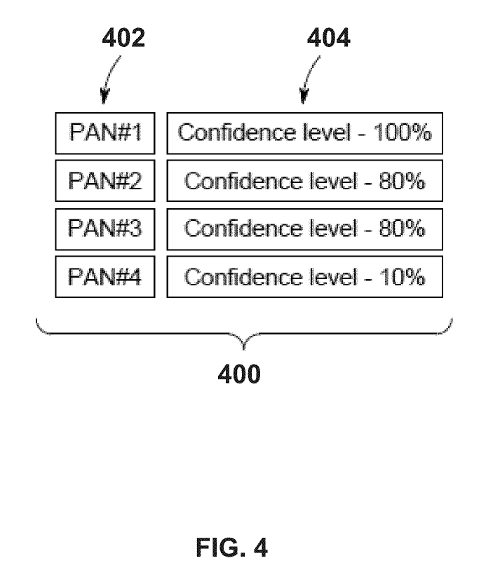

In some non-limiting embodiments or aspects, the CPH system will generally use at least one key identification data element (including a specific key identification data element type and value) from the user as an input and will provide a user account profile 400 for the user including a list of PANs 402 associated with the user. In some non-limiting embodiments or aspects, as shown in FIG. 4, each PAN on the list of PANs 402 may include a confidence level 404 (e.g., a percentage) corresponding to the CPH system's confidence that the respective PAN is associated with the user.

With reference to FIG. 3, at step 302 of process 300, the CPH system will determine the particular key identification data element type (e.g., account identifier, a PAN, a token, an electronic wallet, an electronic device, or a combination thereof) that has been input by the user.

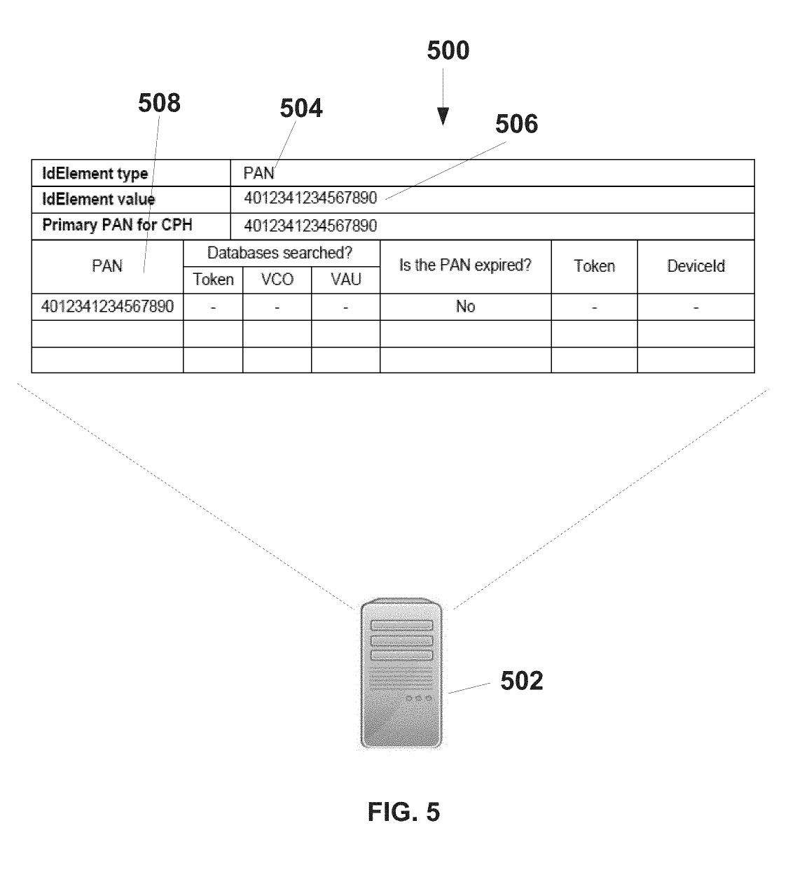

At step 304 of process 300, the CPH system will determine a key identification data element value for the particular key identification data element type. In some non-limiting embodiments or aspects, the key identification data element value may be a PAN, an account identifier number, a device identification number (e.g., an iPhone device ID), a checkout username for a portable financial device account, a token number assigned to a PAN, an electronic wallet identification number, an electronic device identification number, and/or any combination thereof. As shown in FIG. 5, after the key identification data element type and value are determined by the CPH system, a data structure 500 is generated by the CPH system 502. The data structure 500 will include the specific key identification data element type 504 and the inputted key identification data element value 506. The key identification data element value 506 (e.g, the PAN) will also be listed in a key identification data element type list 508.

With reference to FIG. 3, at step 306 of process 300, the CPH system determines a linking identification data element type (e.g., a PAN, an account identifier, a device identification number (e.g., an iPhone device ID), a checkout username for a portable financial device account, a token number assigned to a PAN, an electronic wallet, an electronic device, and any combination thereof) different from the first key identification data element type determined by the CPH system.

With reference to FIG. 3, at step 308 of process 300, a linking identification data element value (e.g., a PAN, an account identifier number, a device identification number (e.g., an iPhone device ID), a checkout username for a portable financial device account, a token number assigned to a PAN, an electronic wallet, an electronic device, and any combination thereof) corresponding to the first key identification data element value is determined.

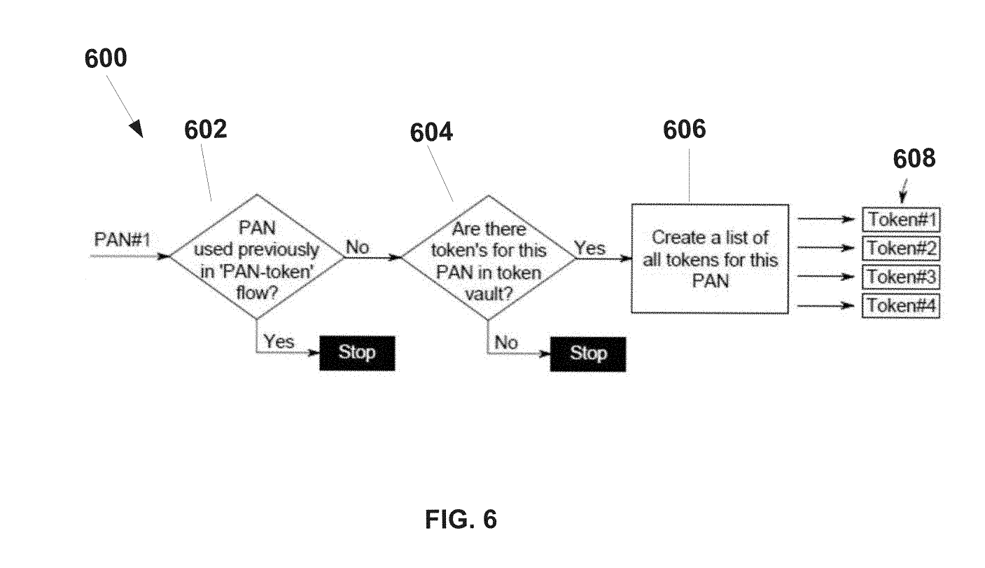

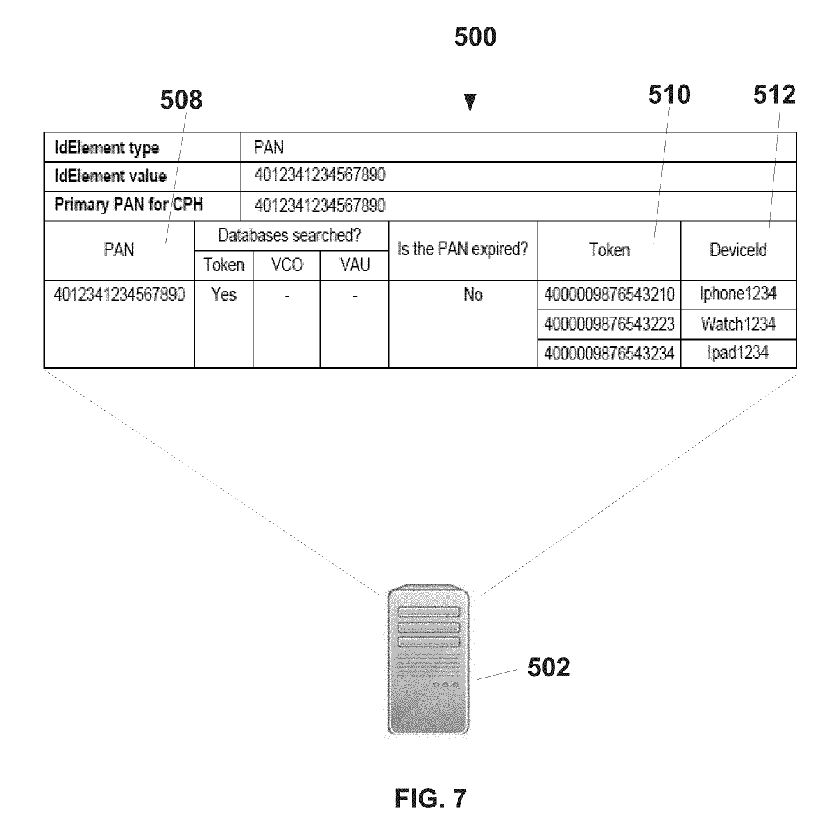

For example, as shown in process 600 in FIG. 6, the CPH system initiates a search logic including a first search protocol to identify all tokens (a type of linking identification data element including a type and value) associated with the inputted PAN. A user's PAN may have multiple tokens in different devices. The PAN may be provisioned in an iPhone (Token #1), an Apple Watch (Token #2), an iPad (Token #3), and a Samsung Galaxy mobile phone (Token #4). In process 600 of the CPH system search logic, the CPH system will identify all tokens associated with the particular PAN. The CPH system will access a token vault to identify any tokens and device identification numbers linked to the particular PAN. For example, at step 602 of process 600, in the event the PAN has been used previously by the CPH system search logic, the search logic is initially stopped. At step 604 of process 600, assuming the PAN has not been previously used and in the event there are no tokens for a particular PAN, the search logic is also stopped. At step 606 of process 600, after the CPH system search logic has identified all of the tokens for a particular PAN, a list of tokens 608 is generated by the CPH system. With reference to FIG. 7, at this stage of the search logic, the CPC system 502 will generate an updated data structure 500 that includes a list of all identified PANs 508 and corresponding token and device identification number lists 510, 512 for the corresponding PAN.

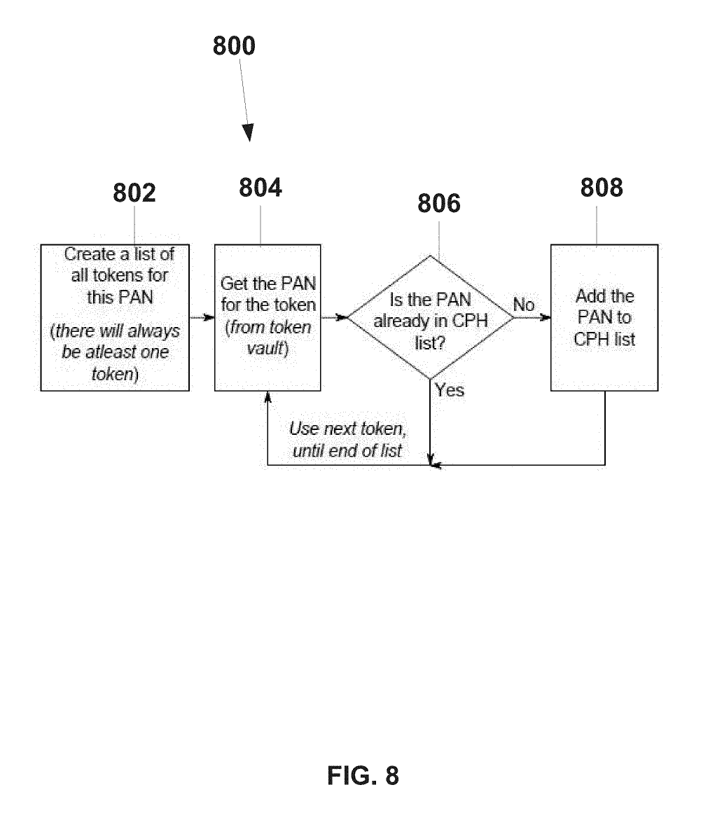

With reference to FIG. 3, at step 310 of process 300, the CPH system will determine a second key identification data element value. For example, with reference to process 800 of FIG. 8, in a second protocol initiated by the CPH system, the CPH system will search a token vault using the identified tokens for any additional PANs that are linked to the same tokens that were identified during the first protocol discussed above to establish any additional PAN-token relationships. A user may link a specific token to multiple PANs on a user device. For example, he/she may add both a Bank of America debit card and a Chase Credit Card in his/her iPhone ApplePay wallet. As a result, once a user device is associated with a particular user via a PAN-to-token query initiated during the first protocol discussed above, the CPH system will query the token vault for all other token-PAN relationships associated with the tokens identified during the first protocol. Therefore, in some non-limiting embodiments or aspects, at step 802 of process 800, during the first protocol of the CPH system search logic, the CPH system search logic will create a list of all tokens associated with a particular PAN. At step 804 of process 800, the search logic will then search for any additional PANs associated with the identified tokens in a token vault and, at step 808 of process 800, add the newly-identified PAN(s) to the PAN list generated by the CPH system. For example, PAN #1 may be linked to Token #1, Token #2, Token #3, and Token #4, which is identified during the first protocol of the CPH system search logic. The second protocol of the CPH system search logic will search the token vault for Token #1 to determine if Token #1 is linked to any additional PANs (e.g., PAN #2, PAN #3, etc.). In the event a newly-identified PAN is generated, this newly-identified PAN is added to the PAN list with PAN #1. At step 806 of process 800, if a PAN has already been listed in the PAN list, the next token (e.g., Token #2) is searched in the token vault by the CPH system search logic until the entire list of tokens has been search for additional PANs.

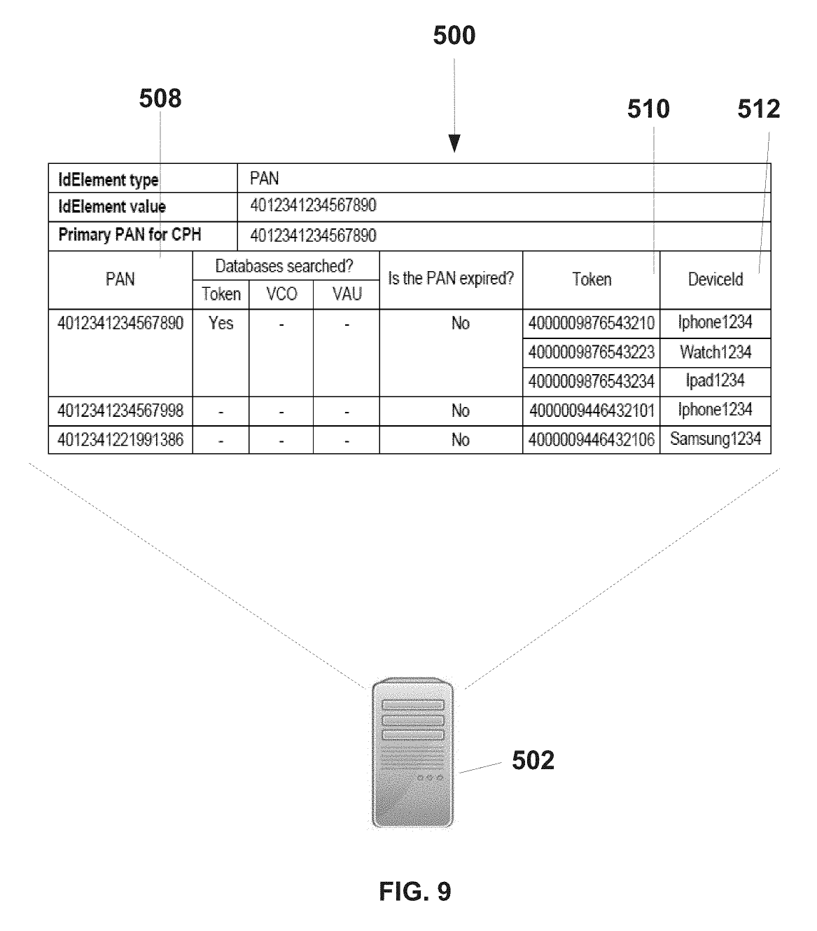

As shown in FIG. 9, after the second protocol has been completed by the CPH system search logic, the newly-identified PAN(s) is identified in the list of PANs 508 in an updated data structure 500. Each PAN includes a corresponding token list 510 and a device identification number list 512. Based on the second protocol initiated by the CPH system search logic, multiple PANs have now been identified due to at least two PANs sharing the same token.

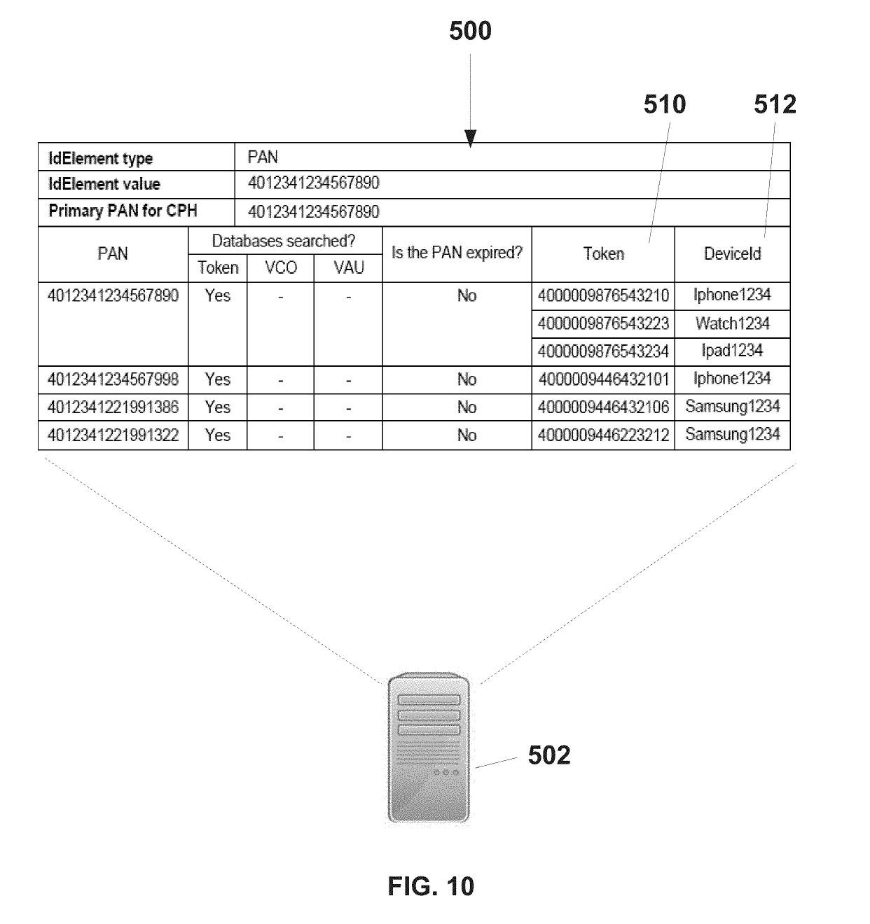

After the second protocol has been completed, the CPH system will return to the first protocol in the event the user has input additional PANs that are sent to the CPH system. The user may input a second PAN to initiate the first protocol of the CPH system search logic with the second inputted PAN. The CPH system will initiate and complete the first and second protocols for the second inputted PAN. After the first and second protocols have been completed for the second inputted PAN, the CPH system will return to the first protocol to determine whether the user has any additional PANs to input. The first and second protocols are repeated for each user PAN until all of the user's inputted PANs have been evaluated. As shown in FIG. 10, after all of the user's PANs have been inputted and the first and second protocols are performed for each PAN, the CPH system 502 generates an updated data structure 500 that includes all of the identified PANs up to this point. Each PAN includes a corresponding token list 510 and a device identification number list 512.

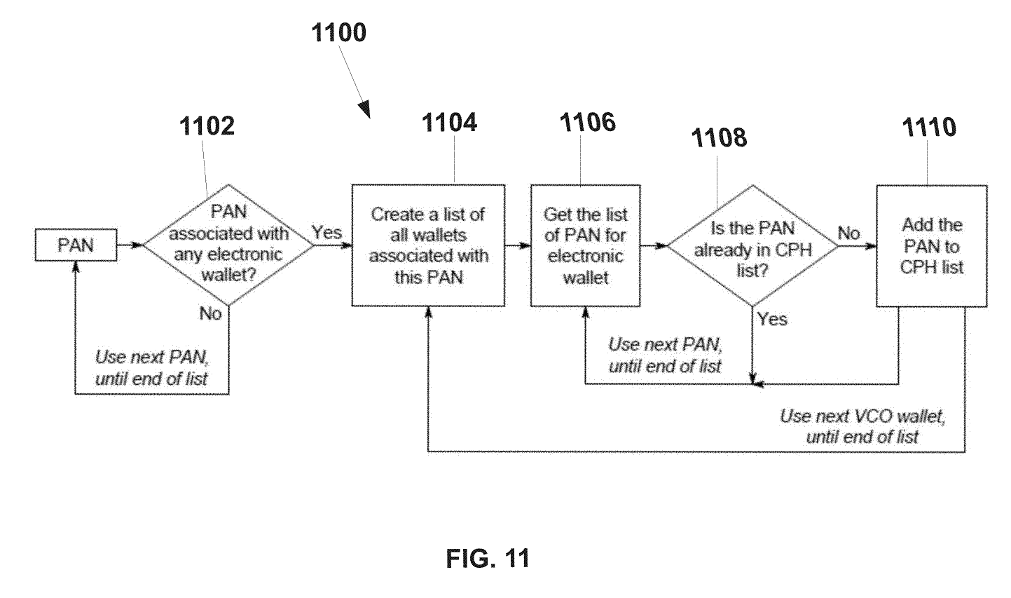

With reference to process 1100 of FIG. 11, after the first and second protocols for all of the user's inputted PANs have been completed, the CPH system initiates a third protocol in which the CPH system determines whether each PAN is associated with any particular electronic wallet(s) (a different type of linking identification data element) for the user. A PAN may be present in one or more electronic wallets, such as a Visa Checkout (VCO) wallet. In one example, spouses may share the same PAN in two different electronic wallets. In addition, a user may add multiple PANs to his/her electronic wallet. For example, he/she may add both a Bank of America debit card and a Chase credit card in his/her Visa Checkout (VCO) electronic wallet. As a result, once an electronic wallet is associated with a particular user PAN, the CPH system will query the electronic wallet for that PAN for any other PAN-electronic wallet relationships to identify additional user PANs.

With continued reference to process 1100 of FIG. 11, at step 1102 of process 1100, the CPH system will first determine whether each PAN on the generated list of PANs is associated with any electronic wallet(s). At step 1104 in process 1100, in the event the PAN is associated with any electronic wallet(s), the CPH system will create a list of all electronic wallets associated with the particular PAN. In the event the PAN is not associated with an electronic wallet, the CPH system will move to the next PAN to determine whether the next PAN is associated with any electronic wallet(s). The CPH system will continue this repeated process until all of the PANs have been searched for corresponding electronic wallets. At step 1106 of process 1100, after the CPH system has determined whether each PAN has an electronic wallet, the CPH system will generate a list of PAN(s) for each particular electronic wallet identified for each particular PAN. At step 1108 of process 1100, the CPH system will then determine whether each of the newly-identified PANs has been identified in the list of PANs previously generated by the CPH system. In the event a particular PAN has already been listed by the CPH system, the CPH system will move to the next PAN to determine whether the next PAN has been previously listed by the CPH system. At step 1110 of process 1100, in the event the PAN has not been previously listed by the CPH system, the CPH system will add the PAN to the generated list of PANs. After each PAN associated with a particular electronic wallet has been evaluated, the CPH system will proceed to evaluate the list of PANs associated with the next identified electronic wallet, until all of the PANs associated with each identified electronic wallet have been evaluated.

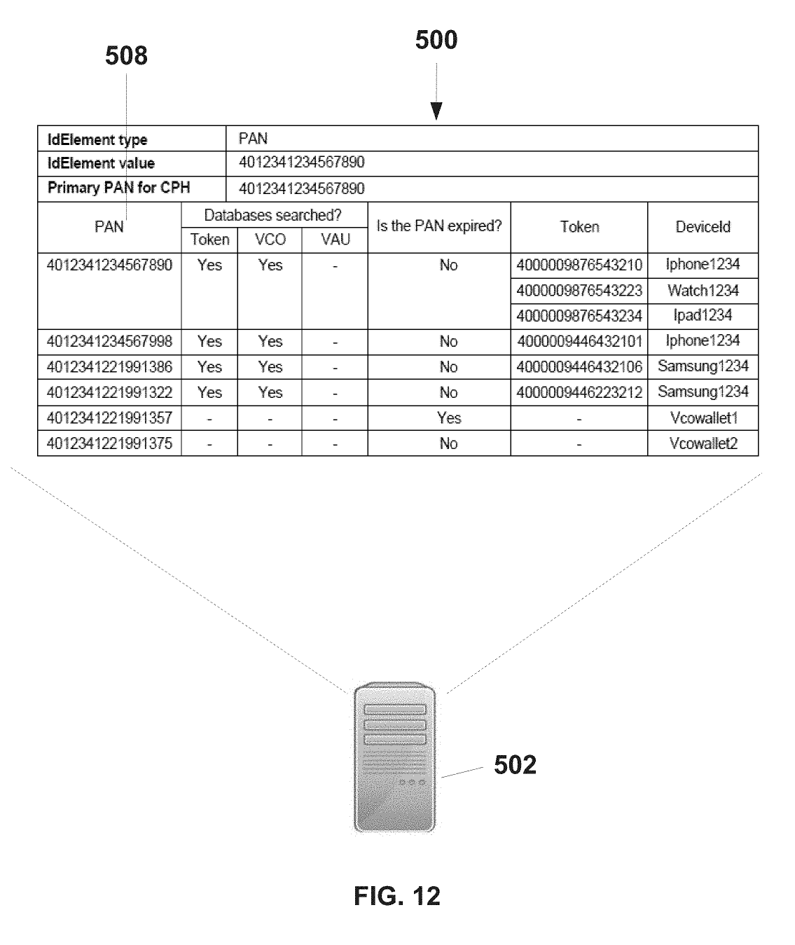

As shown in FIG. 12, after all of the PANs associated with each identified electronic wallet have been evaluated, the CPH system will generate an updated data structure 500 including an updated list of PANs 508 associated with the user, including the newly-identified PANs that correspond to the user's electronic wallets. In the event a particular PAN is expired, the CPH system will still generate the data structure 500 and include this expired PAN on the data structure 500.

After the third protocol has been completed, the CPH system will return to the first protocol in the event additional PANs were identified during the electronic wallet comparisons. The CPH system will initiate and complete the first and second protocols for each of the newly-identified PANs. The first and second protocols are repeated for each PAN until all of the newly-identified PANs have been evaluated. After the first and second protocols are performed for each PAN, a data structure including all of the PANs is generated by the CPH system. Each PAN includes a corresponding token list and a device identification number list.

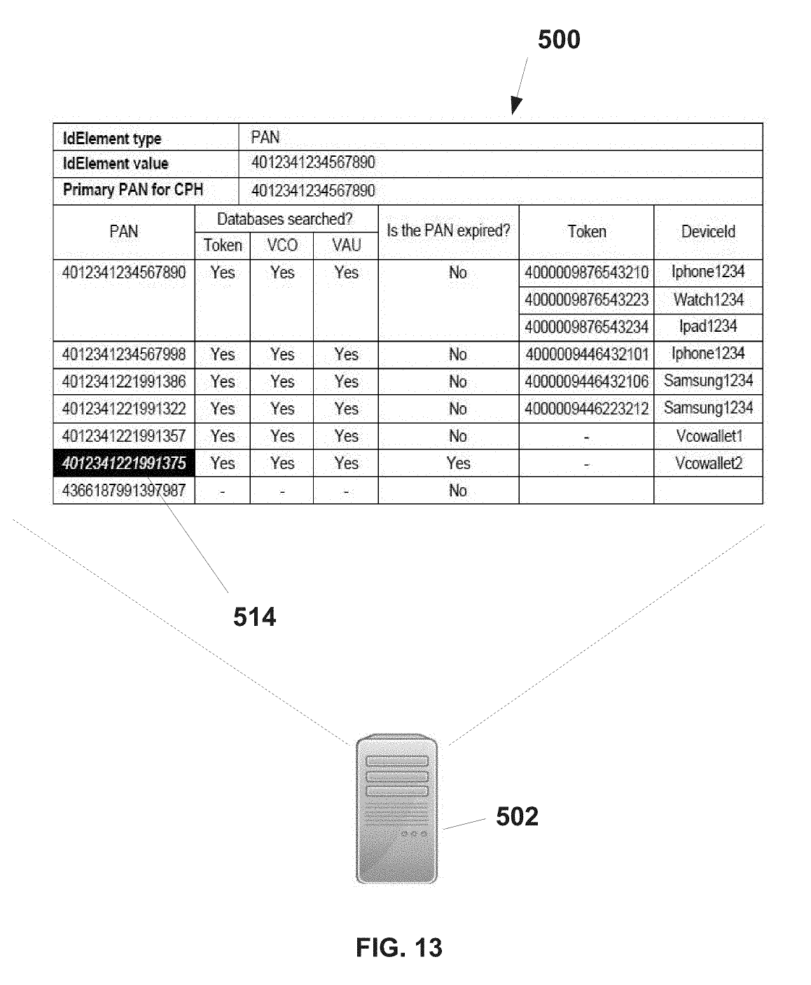

Next, the CPU system will query an account updater database, such as Visa Account Updater database, to identify any PAN replacements that may have occurred. In the event any of the PANs present in the account updater database have been replaced with a new PAN, the CPH system will add the new PANs in the account updater database in place of the original PAN. With reference to FIG. 13, assuming the issuer has replaced a user's PAN using an account updater database service, the data structure 500 generated by the CPH system 502 will include the new PAN 514 instead of the replacement PAN. For example and as shown in FIG. 13, the old PAN 4012341221991375 has been replaced with new PAN 4366187991397987. After the CPH system has queried the account updater database, the CPH system will initiate the first, second, and third protocols for any newly-added PANs on the PAN list to determine if any additional PANs need to be added to the PAN list.

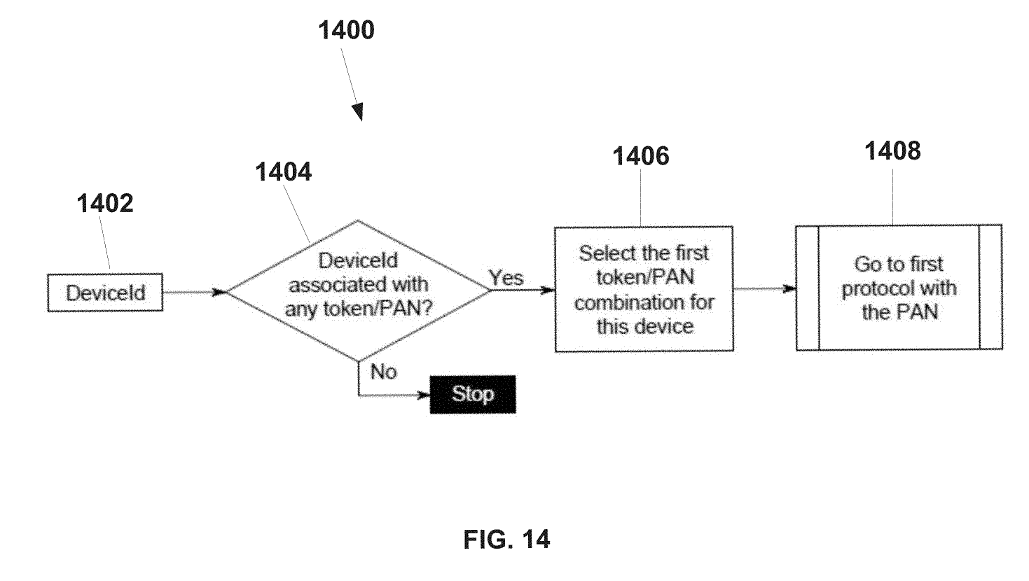

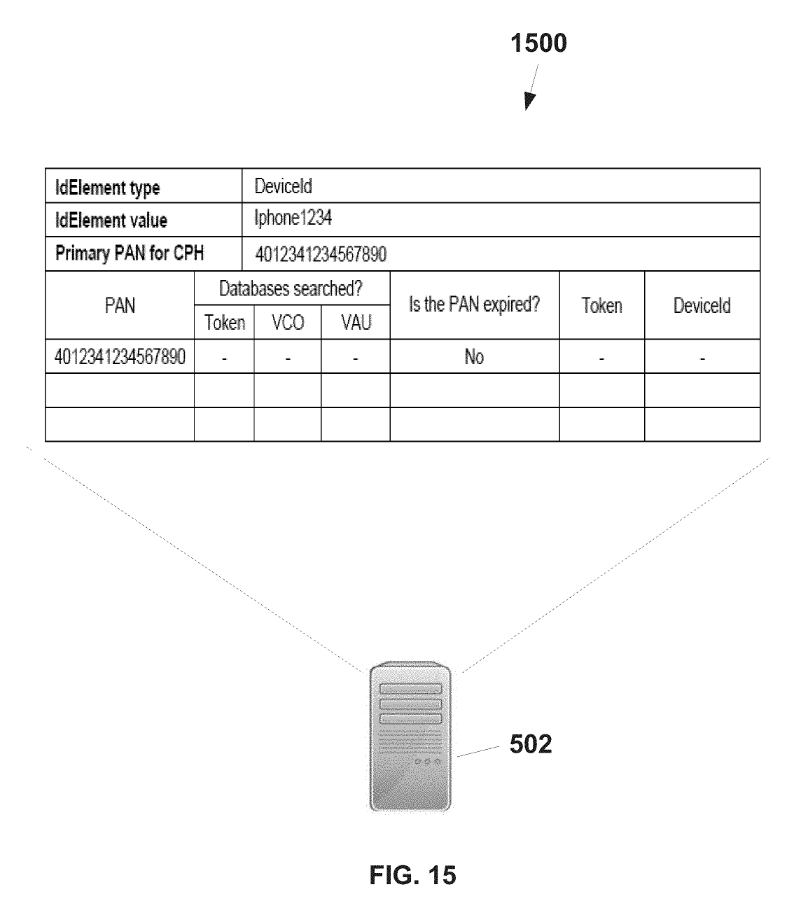

With reference to process 1400 of FIG. 14, in some non-limiting embodiments or aspects of the invention, the CPH system may use a different key identification data element type (a key identification data element type other than a PAN) to generate a PAN list. In some examples, the key identification data element type input may be a user device identification number. At step 1402 of process 1400, after the user has input the user device identification number, this key identification data element information is sent to the CPH system. At step 1404 of process 1400, the CPH system will proceed to determine whether the user device identification number is associated with any tokens or PANs related to the user. In the event the user device identification number is not associated with any token or PAN, the CPH system stops the review procedure. At steps 1406 and 1408 of process 1400, in the event the user device identification number is associated with one or more tokens and/or PANs, the CPH system selects the first token/PAN combination for the user device and proceeds to conduct the first, second, and third protocols of the CPH system search logic for the token/PAN combination. A data structure 1500 generated by the CPH system 502 based on the user device identification number is illustrated in FIG. 15. The CPH system proceeds to select each of the remaining identified token/PAN combinations and conducts the first, second, and third protocols of the CPH system search logic for the remaining token/PAN combinations to generate a list of PANs associated with the user. In other non-limiting embodiments or aspects, different key identification data element types may be used to generate a PAN list. In particular, the different key identification data element types may be used to generate a list of token/PAN combinations that can be used to generate a PAN list using the first, second, and third protocols of the search logic initiated by the CPH system.

With reference to FIG. 3, at step 312 of process 300, the CPH system will generate a user account profile including all of the non-expiring PANs for the user determined by the CPH system. In some non-limiting embodiments and aspects, the user account profile may also include confidence levels for each corresponding PAN. The benefits of generating such a list of PANs for a user will be described in greater detail below.

The user account profile, as shown in FIG. 4, includes a PAN list 402 and a confidence level list 404 that includes a corresponding confidence level for each PAN. In some non-limiting embodiments or aspects, the confidence levels generated by the CPH system correspond to a value that indicates the confidence level of the relationship between the respective PAN and the key identification data element, presented as a 1percentage (0-100%). For example, in the event the key identification data element is a checkout identification number and it has two PANs linked to it but no transaction was initiated from this checkout identification number for the second PAN, the second PAN in the user account profile will have a lower confidence level (e.g., a spouse's PAN may be present in a primary account holder's wallet for emergency use purposes).

In other non-limiting embodiments or aspects, after an initial PAN list is generated by the CPH system based on the first, second, and third protocols of the search logic, the CPH system may further refine the PAN list based on previous transaction information from the user. In some non-limiting embodiments or aspects, the CPH system may search a transaction database, such as a VisaNet database, for any approved authorizations or clearing transactions using the PAN either in the short term (e.g., last three months) or the long term (e.g., last 36 months) and will assign an assessment value, such as a confidence level, to the PAN. In the event there are no transactions using a particular PAN in the short or long term, the CPH system may remove this PAN from the PAN list. For example, the user may have opened a store credit card but never used the store credit card. Therefore, this PAN should be removed from the PAN list as not being particularly relevant to the user. In the event there are transactions using a particular PAN in the long term but not the short term, the CPH system may assign a lower assessment value or confidence score to this particular PAN. For example, a user may have previously used a particular PAN in the last 36 months, but due to a variety of reasons, has stopped using this particular PAN to use a different PAN. Therefore, a lower assessment value or confidence score may be assigned to this particular PAN since the user may be phasing out the use of this particular PAN. In the event there are transactions using a particular PAN in the short and long term, a higher assessment value or confidence score may be assigned to this particular PAN since the CPH system search logic is more confident that the user is currently using this particular PAN and likely intends to continue using this particular PAN in the future.

In other non-limiting embodiments or aspects, the CPH system may search the transaction database for any fraud-related charge-back transactions using a particular PAN identified on the PAN list. In the event there are no fraud-related charge-back transactions for a particular PAN, a higher assessment value or confidence level may be assigned to the particular PAN by the CPH system. In the event there are more than a critical number of fraud-related charge-back transactions for a particular PAN (e.g., three fraud-related charge-back transactions in the last three months), this may be an indication that the PAN has been compromised and, as a result, may have been replaced with a new PAN (which may already be listed in the PAN list generated by the CPH system). Therefore, the CPH system may assign a lower assessment value or confidence level to this particular PAN since there is the possibility that this PAN is no longer active. In some non-limiting embodiments or aspects, the CPH system may also flag these fraud-related charge-back transactions for the PAN in the user's account profile.

In another non-limiting embodiment or aspect, if an expiration date for a particular PAN is not present in a transaction database (e.g., the PAN was not tokenized or the PAN does not have a user database segment), the CPH system will check the expiration date of the particular PAN from the transaction data on the transaction database using the particular PAN. In the event the PAN has expired (e.g., a threshold of three months ago) and there are no transactions for this particular PAN with a new expiration date (e.g., the user has not received a new card with a new expiration date), the user may have received a new PAN or closed the account according to the particular PAN. Therefore, this PAN may be removed from the PAN list generated by the CPH system or may be assigned a lower assessment value or confidence level on the PAN list. In the event a new expiration date is identified for a particular PAN, the CPH system may update the expiration date of the particular PAN in the user's account profile.

After the PAN list filtering has been conducted, the CPH system will generate a user account profile including a final PAN list to the user or transaction provider for further processing. In some non-limiting embodiments or aspects, each PAN listed in the final PAN list may include a corresponding assessment value or confidence level that is correlated to the CPH system's confidence that the particular PAN is active and/or paired to the particular user. In some non-limiting embodiments or aspects, the CPH system is configured with a confidence threshold, in which only PANs with a confidence level higher than the threshold are provided in the final PAN list. For example, the CPH system may establish a threshold of 80% for the PAN list so that only PANs having a confidence level higher than 80% are included on the final PAN list. The user account profile including the final PAN list may then be transmitted to a merchant's system, a transaction service provider's system, an issuer's system, or a user for evaluation.

Based on the search logic described above for the CPH system, a transaction service provider, a merchant, a user, and/or an issuer can determine an account profile that includes each card account for a user. Using only a single piece of information from the user, the transaction service provider can generate a list of potential relevant accounts or PANs for the user and then use transactional history for the user to remove any closed and/or inactive accounts or PANs. The generated list of PANs provides many benefits across a payment ecosystem, including increased fraud detection, better recurring billing management, and more efficient transaction processing, as described in greater detail below.

After the search logic for the CPH system has generated a final list of PANs for a particular user, the resulting final list of PANs represents a payment network's “best known” universe of the user's account numbers, which can subsequently be applied in various processing applications, including user recurring billing management, transaction risk scoring, stand-in transaction processing, and/or consumer abnormal spending detection.

With the increase in e-commerce over the last several years, managing payment credentials stored at numerous online merchants has become challenging for users. Updating a PAN or card expiration date requires cardholders to search through potentially months of card statements to identify all online merchants at which the particular card has been used. In some cases, users may forget about online subscriptions, such that payment cards continue to be charged when the services are no longer needed or wanted.

Using the identified list of user PANs discussed above, the transaction service provider can offer a service to the user to help manage the user's online merchant payment relationships. Using the identified PANs, the transaction history of each PAN can be analyzed to identify recurring online merchants for the user. A combination of a merchant identifier (name, card acceptor identification number), transaction amount (within a certain error tolerance, such as 10%), and transaction date can be used to identify a recurring biller as daily, weekly, monthly, quarterly, semi-annually, or annually. The transaction service provider's system can use the PAN list generated by the CPH system to determine and generate this information. With the specific merchants identified by the transaction service provider's system, several different services can be offered to a user.

In some non-limiting embodiments or aspects, a report identifying which particular card or PAN is used at each recurring billing merchant, along with the frequency and average amount for the transactions, may be generated by the transaction service provider's system and sent to the user. If the user intends to change a payment credential (e.g., an expired card, new PAN), this generated report may be used to quickly identify the particular merchants where the card is used and stored. In other non-limiting embodiments or aspects, the transaction service provider can offer a service where the user can authenticate and then submit the updated credentials to the merchant on behalf of the user. In other non-limiting embodiments or aspects, the user can use the generated report to identify recurring payments to merchants for services that are no longer desired or needed. The transaction service provider can offer a service to the user to block recurring payments on all identified accounts for the particular merchant.

In some non-limiting embodiments or aspects, the generated report may be by the transaction service provider to generate recurring billing amount alerts for the user. Currently, the convenience of recurring billing by merchants often causes the user to overlook billing statements with the knowledge that funds will automatically be paid to the merchant. Changes in billing amounts can often go unnoticed by the user for months. Using the generated report, once the recurring billing merchants have been identified, the transaction service provider can monitor the recurring charges for the user and notify the user if a sudden increase for a particular recurring billing is detected. In some non-limiting embodiments or aspects, using a rolling average, the transaction service provider's system will compare the latest recurring charge and if the recurring charge exceeds a specified or predetermined tolerance level set by the user (e.g., 10% or higher increase in the recurring charge), a notification or alert message can be sent to the user. Using this tolerance level, the user is not notified for minor adjustments from month to month. In some non-limiting embodiments or aspects, the tolerance level can be set by the user, or dynamically determined by the transaction service provider.

In some non-limiting embodiments or aspects, the generated report may be used for service continuity for the user. Upon a user's card expiring or the user closing an account, the user may forget to update merchants with updated payment credentials, resulting in late charges or a disruption in services for the user. In some non-limiting embodiments or aspects, when the transaction service provider's system detects a declined transaction for a recurring merchant in which adequate history has been established for the recurring merchant, the transaction service provider's system can substitute another payment credential on behalf of the user and retry the transaction. After obtaining an approved authorization from the new card issuer, the authorization details can be provided back to the merchant. When the transaction is cleared using the original payment credential, the transaction service provider's system will substitute the alternate PAN (similar to a tokenized transaction). The transaction service provider's system will then send a notification to the user as a reminder to update the credential with the recurring merchant.

In some non-limiting embodiments or aspects, the generated report may be used by the transaction service provider to send missed payment alerts to the user. Some recurring payments are initiated by a user, such as texting a cable provider to initiate a monthly payment. When the transaction service provider's system has identified a recurring payment, the transaction service provider's system can also monitor for any missed payments with the merchant. When a payment is not detected within a certain number of days (which can be set by the user or transaction service provider) beyond the normal payment period on any of the user's accounts, the transaction service provider's system can send an alert to the user as a reminder to initiate payment to the merchant. The alert may be send to a user's mobile device or email, among other notification methods.

In some non-limiting embodiments or aspects, using the generated list of PANs provided by the CPH system, an improved risk and fraud scoring for the user's accounts can be generated. A majority of current transaction risk models are based on an individual PAN for a user. However, if the totality of the user's PANs can be identified, the aggregate transaction data can paint a better picture of the user's habits and activities, thereby strengthening the accuracy of the transaction risk model.

In some non-limiting embodiments or aspects, when the transaction service provider's system detects that one of the user's cards is legitimately being used in a new locale (e.g., the user is overseas on vacation or a business trip), the transaction service provider's system can apply this reported authorized activity to the other identified PANs for the user and can reduce the risk level for other transactions occurring in the same locale across the different PANs for the user. In some non-limiting embodiments or aspects, when the transaction service provider's system identifies a fraudulent transaction occurring at a particular merchant for a particular PAN, the transaction service provider's system can raise the risk level of the user's other cards used at the same merchant location. This is particularly useful in containing the impact of a merchant data breach where payment credentials were accessed. A notification can also be generated and sent by the transaction service provider's system to the user to warn the user to be cognizant of any other suspicious activity on monthly statements for other accounts identified for the user. In some non-limiting embodiments or aspects, all of the user's cards may become prone to fraudulent activity in the event the user's wallet or purse is lost or stolen. If suspicious activity is detected by the transaction service provider's system for one of the user's cards, the transaction service provider's system can notify the user through an automated alert that the user's other cards or accounts identified in the final list of PANs may be compromised. If the user responds to the transaction service provider's alert with a lost/stolen wallet indication, the transaction service provider's system can automatically raise the risk level of the user's other identified cards or accounts.

In some non-limiting embodiments or aspects, the generated final list of PANs by the CPH system may be used to improve stand-in processing for the transaction service provider. Similar to transaction risk modeling, knowledge of the user's totality of cards or accounts can improve stand-in processing for the transaction service provider in the event the card issuer is unavailable to authorize a transaction. Current stand-in decision services are based on a bank identification number (BIN), and to some extent, the user PAN. By using additional intelligence from the user's other cards or accounts, more accurate risk tolerances can be dynamically set. For example, the transaction service provider's system can calculate a rolling spend profile for a user across the user's accounts (e.g., 30 day window, 50 day window). If stand-in processing is required, the transaction service provider's system can re-calculate the current spending across the user's cards or accounts and compare the activity to the user's historical performance. In the event the spending is lower than anticipated, various spend limits can be raised across all of the user's cards or accounts. Conversely, if the spending is much higher than the user's historical performance, a more conservative stand-in limit can be applied to the user's cards or accounts. The user spending profile may include at least one of a transaction value, a transaction timeframe, a transaction pattern, user behavior data, merchant data, or any combination thereof.

In some non-limiting embodiments or aspects, the generated final list of PANs by the CPH system may be used for consumer abnormal spending detection. A majority of users follow a regular transaction pattern on their cards or accounts. Sudden deviations from this regular pattern can signify changing financial circumstances, potentially impacting the ability of the user to meet debt repayment obligations. For example, a user entering bankruptcy proceedings may suddenly initiate a spending spree across all of the user's cards or accounts with the knowledge that the monthly repayment will not be made to the card issuers. This behavior is often difficult to detect for an individual issuer that has visibility to only one of the user's cards or accounts. However, in aggregate across all of the user's cards, major deviations from typical spending patterns can be more easily detected.

In some non-limiting embodiments or aspects, when the user's cards or accounts across all issuers has been identified by the CPH system, the transaction service provider's system can monitor spending across all of the user's cards or accounts for unusual spending behavior. When unusual spending behavior is detected for one of the user's cards or accounts, the transaction service provider's system can send an indicator or notification in the authorization request to the issuer of this elevated spending on the user's card or account. The issuer can then use this notification, along with other indicators, to provide an authorization response that better balances risk for the issuer with the user's satisfaction. For example, the issuer may authorize the CPH system to modify the spending limit of the user based on the updated spending profile. The aggregate view of the user's spending activity can help issuers detect a bankruptcy situation for a user more quickly than waiting for missed monthly payments with the issuer, while accumulating even higher financial liabilities.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

The invention claimed is

1. A computer-implemented method for automatically generating an account profile for at least one user associated with a plurality of account identifiers, comprising:
determining, with at least one processor, a first key identification data element type comprising at least one of the following: an account identifier, a primary account number, a token, an electronic wallet, an electronic device, or any combination thereof;
determining, with at least one processor, a first key identification data element value corresponding with the at least one user;
determining, with at least one processor, a linking identification data element type different than the first key identification data element type;
based at least partially on the key identification data element value, determining, with at least one processor, at least one linking identification data element value corresponding to the first key identification data element value;
based at least partially on the at least one linking identification data element value, determining, with at least one processor, at least one second key identification data element value; and
generating, with at least one processor, an account profile for the at least one user, the user account profile comprising a plurality of key identification data element values associated with the at least one user.

2. The method of claim 1, further comprising:
determining, with at least one processor, a second linking identification data element type different than the second key identification data element type;
based at least partially on the at least one second key identification data element value, receiving or determining, with at least one processor, at least one second linking identification data element value corresponding to the at least one second key identification data element value; and
based at least partially on the at least one second linking identification data element value, determining, with at least one processor, at least one third key identification data element value.

3. The method of claim 1, further comprising:
determining, with at least one processor, user data associated with the at least one user;
based at least partially on the user data, querying, with at least one processor, a central user database comprising update data corresponding to each of the key identification data element values in the user account profile; and
modifying at least one key identification data element value in the user account profile with an updated key identification data element value corresponding to at least one key identification data element type.

4. The method of claim 3, further comprising:
determining, with at least one processor, a linking identification data element type different than the at least one key identification data element type;
based at least partially on the updated key identification data element value, receiving or determining, with at least one processor, at least one linking identification data element value corresponding to the updated key identification data element value;
based at least partially on the at least one linking identification data element value, determining, with at least one processor, at least one second key identification data element value; and
updating, with at least one processor, the user account profile for the at least one user with the at least one second key identification data element value.

5. The method of claim 1, wherein the at least one user comprises a plurality of users associated with each other.

6. The method of claim 1, further comprising:
identifying, with at least one processor, at least one transaction associated with at least one key identification data element value in the user account profile;
determining, with at least one processor, a transaction timeframe corresponding to the at least one transaction; and
based on the transaction timeframe, assigning, with at least one processor, an assessment value to the at least one key identification data element value.

7. The method of claim 1, further comprising:
identifying, with at least one processor, at least one charge-back transaction associated with at least one key identification data element value in the user account profile; and
in response to determining that the at least one charge-back transaction is associated with a fraud category, flagging, with at least one processor, the at least one key identification data element value in the user account profile.

8. The method of claim 1, wherein the key identification data element value comprises a primary account number of the at least one user, the method further comprises:
in response to failing to identify an expiration date of the primary account number, identifying, with at least one processor, at least one transaction associated with the primary account number;
determining, with at least one processor, the expiration date of the primary account number from transaction data corresponding to the at least one transaction; and
flagging, with at least one processor, the primary account number in the user account profile.

9. The method of claim 8, further comprising updating, with at least one processor, the expiration date associated with the flagged primary account number in the user account profile.

10. The method of claim 8, further comprising:
querying, with at least one processor, a central user database comprising account data corresponding to the at least one user; and
in response to determining that the primary account number has changed, updating, with at least one processor, the primary account number in the user account profile.

11. The method of claim 1, further comprising transmitting, with at least one processor, specified data corresponding to at least one of the key identification data element values in the user account profile to at least one merchant system.

12. The method of claim 1, further comprising:
extracting, with at least one processor, a transaction value from transaction data of a current transaction corresponding to a first key identification data element value between the at least one user and a merchant, a transaction value;
extracting, with at least one processor, a transaction value from transaction data of a previous transaction corresponding to the first key identification data element value between the at least one user and the merchant;
comparing, with at least one processor, the transaction value of the current transaction and the transaction value of the previous transaction; and
in response to determining that the transaction values are different or a difference between the transaction values exceeds a predetermined tolerance level, generating, with at least one processor, at least one alert message.

13. The method of claim 1, further comprising:
in response to determining that a transaction associated with a first key identification data element value has been declined by a merchant system, selecting, with at least one processor, an alternate first key identification data element value; and
transmitting, with at least one processor, the alternate first key identification data element value to the merchant system.

14. The method of claim 1, further comprising:
in response to determining that a recurring payment using at least one first key identification data element value has not occurred within a specified time period, generating, with at least one processor, an alert message; and
transmitting, with at least one processor, the alert message to the at least one user.

15. The method of claim 1, further comprising:
generating, with at least one processor, a risk/fraud score associated with a first specified first key identification data element value;
verifying, with at least one processor, a parameter of a transaction associated with the second specified first key identification data element value; and
in response to the verified parameter, adjusting, with at least one processor, the risk/fraud score associated with the first specified first key identification data element value.

16. The method of claim 1, further comprising:
generating, with at least one processor, a spending profile associated with the key identification data element values; and
in response to receiving a transaction authorization request and based at least partially on the spending profile, transmitting, with at least one processor, an authorization response message.

17. The method of claim 16, wherein the authorization response message is transmitted to at least one merchant.

18. The method of claim 16, further comprising:
based at least partially on the spending profile, determining, with at least one processor, a spend limit value; and
based at least partially on the spending limit value and a transaction value in the transaction authorization request, transmitting, with at least one processor, an authorization response message.

19. The method of claim 18, further comprising modifying, with at least one processor, the spend limit value based at least partially on an updated spending profile.

20. The method of claim 16, wherein the spending profile comprises at least one of the following: transaction value, transaction timeframe, transaction pattern, user behavior data, merchant data, or any combination thereof.

21. A system for automatically generating an account profile for at least one user associated with a plurality of account identifiers, comprising at least one server computer including at least one processor, the at least one server computer programmed and/or configured to:
determine, with at least one processor, a first key identification data element type comprising at least one of the following: an account identifier, a primary account number, a token, an electronic wallet, an electronic device, or any combination thereof;
determine, with at least one processor, a first key identification data element value corresponding with the at least one user;
determine, with at least one processor, a linking identification data element type different than the first key identification data element type;
based at least partially on the key identification data element value, determine, with at least one processor, at least one linking identification data element value corresponding to the first key identification data element value;
based at least partially on the at least one linking identification data element value, determine, with at least one processor, at least one second key identification data element value; and
generate, with at least one processor, an account profile for the at least one user, the user account profile comprising a plurality of key identification data element values associated with the at least one user.

22. A computer program product automatically generating an account profile for at least one user associated with a plurality of account identifiers, comprising at least one non-transitory computer-readable medium including program instructions that, when executed by at least one processor, cause the at least one processor to:
determine, with at least one processor, a first key identification data element type comprising at least one of the following: an account identifier, a primary account number, a token, an electronic wallet, an electronic device, or any combination thereof;
determine, with at least one processor, a first key identification data element value corresponding with the at least one user;
determine, with at least one processor, a linking identification data element type different than the first key identification data element type;
based at least partially on the key identification data element value, determine, with at least one processor, at least one linking identification data element value corresponding to the first key identification data element value;
based at least partially on the at least one linking identification data element value, determine, with at least one processor, at least one second key identification data element value; and
generate, with at least one processor, an account profile for the at least one user, the user account profile comprising a plurality of key identification data element values associated with the at least one user.
